(19) United States
(12) Patent Application Publication
(10) Pub. No.: US 2024/0083492 A1
(43) Pub. Date: Mar. 14, 2024

(54) DUAL MOTOR DRIVE ASSEMBLY

(71) Applicant: ZF Automotive UK Limited, Solihull (GB)

(72) Inventors: Russell Wilson-Jones, Stratford upon Avon (GB); Mark Anthony Wilkes, Kings Norton (GB)

(21) Appl. No.: 18/461,072

(22) Filed: Sep. 5, 2023

(30) Foreign Application Priority Data
Sep. 8, 2022 (GB) 2213119.7

(51) Int. Cl. B62D 5/04; B62D 15/02

(52) U.S. Cl. CPC B62D 5/0403; B62D 5/0409; B62D 5/046; B62D 15/0235

(57) ABSTRACT

A dual-motor drive assembly, comprising a housing, a shaft rotatably mounted to the housing, a first gear connected to the shaft, first and second motors, each driving a respective output gear which are engaged with the first gear, a motor controller allocating torque demands to the first and second motors to apply a torque to the first gear, a determination unit for an angular position signal of the first and second motors, and a processing unit receiving the angular position signals when the motor controller allocates a torque demand that produces a differential torque at the shaft having a first sense; the differential torque taking up any free-play between the two output gears and the first gear, receiving the angular position signals—when the motor controller allocates a torque demand that produces a differential torque at the shaft having a second sense, the differential torque taking up any free-play between the two output gears and the first gear, and the processing arrangement estimates the level of backlash in the gearbox as a function of the values of the angular position signals at first and second times.

### CROSS-REFERENCE TO RELATED APPLICATION

This application claims priority to GB Priority Application No. 2213119.7, filed Sep. 8, 2022, the disclosure of which is incorporated herein by reference in its entirety.

### TECHNICAL FIELD

This disclosure relates to a dual motor drive assembly, in particular, but not exclusively, suitable for use in a handwheel actuator (HWA) assembly of a vehicle.

### BACKGROUND

Electric motors are widely used and are increasingly common in automotive applications. For example, it is known to provide an electrically power assisted steering system in which an electric motor apparatus applies an assistance torque to a part of a steering system to make it easier for the driver to turn the wheels of the vehicle. The magnitude of the assistance torque is determined according to a control algorithm which receives as an input one or more parameters such as the torque applied to the steering column by the driver turning the wheel, the vehicle speed and so on.

Another example of use of electric motors in automotive applications in in steer-by-wire systems. During normal use, these systems have no direct mechanical link from the hand wheel that the driver moves and the steered wheels with movement of the hand wheel by the driver being detected by a sensor and the motor being driven in response to the output of the sensor to generate a force that steers the road wheels. These systems rely on sensors to relay user input data at a steering wheel to control units which integrate user input data with other information such as vehicle speed and yaw rate, to deliver control signals to a primary motor that physically actuates a steering rack of the vehicle. The control units also act to filter out unwanted feedback from the front wheels and provide a response signal to a secondary electric motor coupled to the steering wheel. The secondary motor provides the driver with the appropriate resistance and feedback in response to specific user inputs at the steering wheel to mimic the feel of a conventional steering system.

In a steer-by-wire system, a malfunction or failure of a portion of the assembly may impair the ability to steer the vehicle. As a result, it is desirable to provide the assembly with structure for providing at least temporary tail-safe operation. US 2006/0042858 A1 discloses steering apparatus including a steering assembly that includes a handwheel actuator. The handwheel actuator includes a steering column for supporting a steering wheel, a gear mechanism and two motors, each for providing a torque to the steering column.

GB 2579374 A discloses a steering column assembly for use with a steer-by-wire hand wheel actuator. This assembly utilises a similar dual motor drive system that comprises first and second motors, each having an output driving a respective output gear. Each output gear drives a first gear which is connected to and configured to rotate a shaft of the steering wheel to provide a sensation of road feel to the driver. The dual motor drive system is used to reduce gear rattle by driving both motors at the same time to apply opposing torques to the steering column. Having two motors also provides for some redundancy in the system.

Over time, gearbox components will become worn and tolerances, such as those between the teeth of meshed gears, will increase. Changes in gaps, tolerances, backlash or the like may result in different operating requirements and eventually components will need to be replaced.

### SUMMARY

The present disclosure seeks to ameliorate the problems associated with conventional motor assemblies.

In accordance with a first aspect of the present disclosure there is provided a dual motor drive assembly, for use in a handwheel actuator assembly of a vehicle, comprising:
a housing;
a shaft rotatably mounted with respect to the housing;
a first gear connected to and configured to rotate with the shaft;
first and second motors, each having an output driving a respective output gear, the output gears being engaged with the first gear;
a motor controller which allocates torque demands to each of the first and second motors to cause each motor to apply a respective torque to the first gear,
a position determining arrangement for determining a respective angular position signal indicative of the angular position of the first motor and the angular position of the second motor,
and a processing arrangement configured to:
   receive the angular position signals at a first time when the motor controller allocates a torque demand to the motors that produces a differential torque at the shaft having a first sense; the differential torque being sufficient to overcome friction between the gears and to ensure that any free play between the two output gears and the first gear is taken up;
   receive the angular position signals at a second time when the motor controller allocates a torque demand to the motors that produces a differential torque at the shaft having a second, opposite sense, the differential torque being sufficient to overcome friction between the gears and to ensure that any free play between the two output gears and the first gear is taken up,
and in which the processing arrangement estimates the level of backlash in the gearbox as a function of the values of the angular position signals at the first and second times.

The processing arrangement may determine from the angular position signal the differential motion of the two motors between the first time and the second to estimate the backlash. Where there is zero backlash there will be no change in the differential motion at the two times. As backlash increases the differential motion will increase. The higher the backlash the more movement is needed on reversal of torque direction to go from the gears being fully meshed in one direction to fully meshed in the other as there is a greater amount of free play present. When free play is being taken up, there will be no transfer of torque from the motors to the output shaft through the gearbox.

The dual motor drive assembly may form part of a hand wheel actuator (HWA). The HWA may form part of a vehicle. A handwheel may be operably connected to the shaft.

The first gear may comprise a wormwheel gear. Each output gear may comprise a worm screw.

Backlash may be described as a clearance or lost motion in the assembly caused by gaps between the first gear and the output gears. With respect to the first gear and output gears, backlash may be defined as the amount of clearance between mated gear teeth.

The estimated backlash can be used to indicate wear-out in the gearbox components. In this way, wear of the components can be checked over time and replacements can be made when required.

The motor controller which allocates torque demands may comprise an electronic control unit. This may comprise any suitable controller, control unit or the like. The motor controller may also be configured to drive the motors during normal use of the dual motor assembly, or may be a stand alone motor controller used for the estimation of backlash.

The motor controller may at the first time cause the motors to apply opposing torques that may be described as a positive differential torque. At the second time the opposing torques provided by the motors may be described as a negative differential torque.

The processing arrangement may drive the two motors with positive and negative differential torques at the first and second time which cause the shaft to rotate at a first speed. The processing arrangement may be arranged to repeat this process multiple times, such that a difference between the demand torque of the first motor and the torque of the second motor may be varied. On each occasion the backlash is estimated from the differential positions of the motors. This allows for a backlash measurement to be made at different differential motor torques, as it is known that the backlash will generally be higher at higher differential torques than at lower differential torques due to elastic deformation of the gears and other parts of the assembly.

The dual motor drive assembly may comprise an arrangement to estimate the level of backlash by observing the differential motion of the two motors at moments of time during a power-up or power-down sequence of the dual motor assembly. In this way, the level of backlash may be estimated when the assembly may be largely inactive. For example, this could be done as part of a power-up or power-down test sequence. The level of backlash may be estimated when the HWA is operating but largely inactive, for example this could be when the vehicle is operating semi-autonomously.

A closed-loop control system may be used to hold the handwheel at a substantially constant angle by varying the torque demand to both motors.

The dual motor drive assembly may comprise a handwheel actuator assembly for a vehicle and the processing arrangement may be arranged to estimate the level of backlash by observing the differential motion of the two motors during a period of operation with near-zero motion of the shaft. A handwheel or yoke is typically fixed to the shaft, and observing motion when the shaft is not rotating or near-zero will avow the estimate to be taken in an unobtrusive way without the handwheel moving or moving only a small amount.

The dual motor drive assembly may comprise a means to continuously monitor the gearbox backlash by measuring the differential motion of the two motors whenever the two motors are driving in opposition, the processing arrangement selecting any two first and second moments of time for the angular position measurements during use of the assembly. The differential motion of the two motors may be measured when the total torque demand is at or above a pre-determined value, the pre-determined value be approximately an amount sufficient to fully engage the teeth of the first gear and output gears.

According to a second aspect of the disclosure there is provided a method of operating a dual motor drive assembly, for use in a handwheel actuator assembly of a vehicle, comprising:
a housing;
a shaft rotatably mounted with respect to the housing;
a first gear connected to and configured to rotate with the shaft;
first and second motors, each having an output driving a respective output gear, the output gears being engaged with the first gear;
wherein the method comprises the steps:
(a) allocating torque demands to each of the first and second motors, wherein the first and second motors apply opposing torques to the first gear resulting in an overall differential torque at the shaft which is sufficient to overcome friction between the gears and to ensure that any free play between the two output gears and the first gear is taken up;
(b) switching the polarities of the torque applied by both the first and second motors between a first moment in time and a second moment in time wherein at the first moment in time the differential torque at the shaft applied by the motors is opposite in value to the differential torque at the second moment in time; and
(c) measuring the differential motion of the two motors at the two moments in time, wherein the level of backlash in the gearbox is estimated using the differential motion of the first and second motors.

Except where mutually exclusive, any of the features of any of the above described aspects may be employed mutatis mutandis in any of the other above described aspects.

### BRIEF DESCRIPTION OF DRAWINGS

Example exemplary arrangements will now be described with reference to the accompanying drawings, in which:

FIG. 1 shows an exemplary arrangement of a dual motor drive assembly according to a first aspect of the disclosure;

FIG. 2 shows a part of the dual motor drive apparatus of FIG. 1 with the gearbox housing removed to better show the gears and the motor connection to the gears;

FIG. 3 shows another exemplary arrangement of a dual motor drive assembly according to a first aspect of the disclosure;

FIG. 4 shows a general arrangement of an electronic control unit which controls the two motors of a dual motor drive assembly according to a first aspect of the disclosure;

FIG. 5 shows a layout of a Steer-by-Wire system including a dual motor drive assembly according to a first aspect of the disclosure;

FIG. 6 shows a relationship between the feedback torque demanded and the feedback torque applied for a dual motor drive assembly according to a first aspect of the disclosure;

FIG. 7 shows an exemplary arrangers ent of a dual motor drive assembly according to a first aspect of the disclosure when a total demanded torque is in a low torque region and a positive differential torque is applied;

FIG. 8 shows dual motor drive assembly of FIG. 7 when a total demanded torque is in a low torque region and a negative differential torque is applied;

FIG. 9 shows an example operating scheme implemented by a closed-loop control system of the dual motor drive assembly of FIGS. 7 and 8; and

FIG. 10 shows schematically an example arrangement of the closed-loop control system of the dual motor drive assembly of FIGS. 7 and 8.

### DETAILED DESCRIPTION

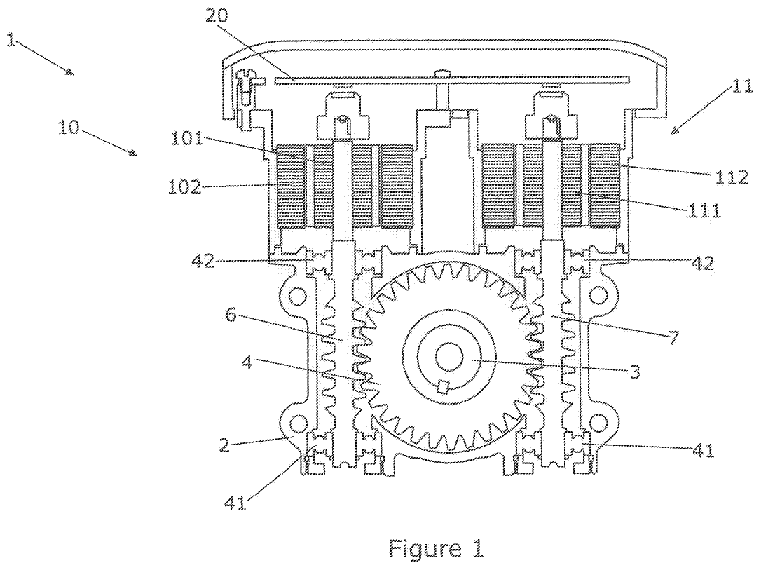

FIG. 1 shows a dual motor drive assembly, suitable for use in a handwheel actuator (HWA) assembly of a vehicle, according to a first aspect of the disclosure. The drive assembly 1 includes a first motor 10 with a rotor 101 and stator 102 and a second motor 11 with a rotor 111 and stator 112, the first motor 10 being connected to a first worm screw 6 and the second motor 11 being connected to a second worm screw 7, Each worm screw 6, 7 comprises a threaded shaft arranged to engage with a wormwheel gear 4 connected to a steering column shaft 3 such that torque may be transferred from the worm screws 6, 7 to the wormwheel gear 4 connected to the steering column shaft 3. The wormwheel gear 4 is operatively connected to a driver's handwheel (not shown) via the steering column shaft 3. In this example, each of the two motors 10, 11 are brushless permanent magnet type motors and each comprise a rotor 101, 111 and a stator 102, 112 having many windings surrounding regularly circumferentially spaced teeth. The arrangement of the two motors 10, 11, the shaft 3, the worm screws 6, 7 and the wheel gear 4 together form a dual motor electrical assembly.

Each of the two motors 10, 11 are controlled by an electronic control unit (ECU) 20. The ECU 20 controls the level of current applied to the windings and hence the level of torque that is produced by each motor 10, 11.

In this example, the two motors 10, 11 are of a similar design and produce a similar level of maximum torque. However, it is within the scope of this disclosure to have an asymmetric design in which one motor 10, 11 produces a higher level of torque than the other 10, 11.

One of the functions of a handwheel actuator (HWA) assembly is to provide a feedback force to the driver to give an appropriate steering feel. This may be achieved by controlling the torque of the motors 10, 11 in accordance with signals from the handwheel actuator (such as column angle) and from other systems in the vehicle (such as vehicle speed, rack angle, lateral acceleration and yaw rate).

The use of two motors 10, 11 is beneficial in eliminating rattle. If a single electric motor were instead used in a torque feedback unit, the motor may be held in locked contact with the gearing by a spring. However, in certain driving conditions the action of a spring is not sufficiently firm, which allows the gears to “rattle” during sinusoidal motions or sharp position changes of the steering column.

Use of two motors 10, 11 which can be actively controlled (as in the present embodiment) ameliorates the problems associated with use of a single motor. In this arrangement, both motors 10, 11 are controlled by the ECU 20 to provide torque feedback to the steering column and to ensure that the worm screws 6, 7 of both motors 10, 11 are continuously in contact with the wormwheel gear 4, in order to minimise rattle. The use of two motors 10, 11 in this way also allows active management of the friction and thereby the feedback force to the driver.

As shown in FIG. 1, the motors 10, 11 are received in and secured to a transversely extending two-part extension of a housing 2. The worm screw 6, 7 of each motor is supported relative to the housing by two sets of bearings. A first set of bearings 41 supports a first end of each worm screw 6, 7 distal their respective motor 10, 11 while a second set of bearings 42 supports a second end of each worm screw 6, 7 proximal their respective motor 10, 11.

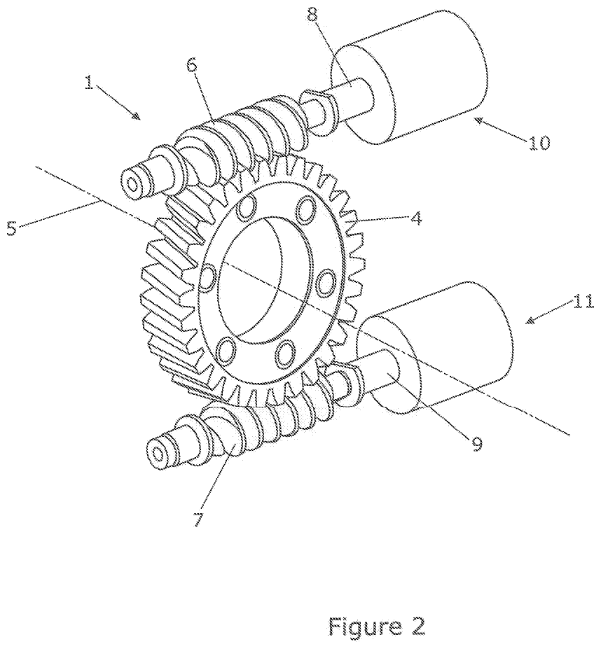

FIG. 2 shows an axis of rotation of shaft 3 marked using a dashed line 5, extending perpendicularly through the wormwheel gear 4. The periphery of the wormwheel gear 4 is formed as a worm screw which meshes with each of two identical worm screws 6, 7 located on opposite sides of the longitudinal axis 5 of the shaft 3. Each worm screw 6, 7 is connected to the output shaft 8, 9 of a respective electric motor 10, 11.

The axes of the output shafts 8, 9 of the two motors 10, 11 are arranged perpendicularly to the rotational axis of the shaft 3 and the axes of the two motors may also be inclined with respect to each other, to reduce the overall size of the assembly.

The motors 10, 11 are controlled by the electronic control unit (ECU) 20 such that at low levels of input torque applied to the shaft 3 by the handwheel, the motors 10, 11 act in opposite directions on the wormwheel gear 4 to eliminate backlash. At higher levels of input torque applied to the shaft 3 by the handwheel, the motors 10, 11 act in the same direction on the wormwheel gear 4 to assist in rotation of the shaft 3. Here, a motor 10, 11 acting in ‘a direction’ is used indicate the direction of torque applied by a motor 10, 11 to the wormwheel gear 4.

In the exemplary arrangement shown in FIGS. 1 and 2, the worm screws 6, 7 engage diametrically opposed portions of a wormwheel gear 4. The threads of the worm screws 6, 7 each have the same sense, i.e., they are both left-handed screw threads. The motors 10, 11 are configured such that they lie on the same side of the wormwheel gear 4 (both motors 10, 11 lie on one side of a virtual plane perpendicular to axes of the worm screws 6, 7 and passing through the centre point of the wormwheel gear 4), Considering as an example the perspective shown in FIG. 2, driving both motors 10, 11 clockwise would apply torque in opposite directions to the wormwheel gear 4, with motor 10 applying a clockwise torque to wormwheel gear 4 and motor 11 applying an opposing anti-clockwise torque to wormwheel gear 4.

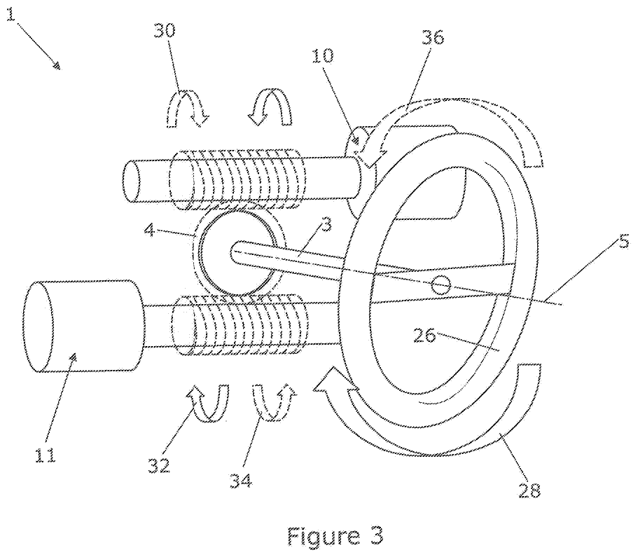

FIG. 3 shows another exemplary arrangement of a dual motor drive assembly, substantially similar to the arrangement shown in FIGS. 1 and 2 but with different motor positioning.

FIG. 3 shows another exemplary arrangement of a dual motor drive assembly 1 according to the first aspect of the disclosure. This exemplary arrangement is substantially similar to the disclosure shown in FIGS. 1 and 2 with the only difference being the positioning of the motors 10, 11. Components and functional units which in terms of function and/or construction are equivalent or identical to those of the preceding arrangement are provided with the same reference signs and are not separately described. The explanations pertaining to FIG. 1 and FIG. 2 therefore apply in analogous manner to FIG. 3 with the exception of the positioning of the two motors 10, 11.

In FIG. 3 the worm screws 6, 7 engage diametrically opposed portions of a wormwheel gear 4 and threads of the worm screws 6, 7 each have the same sense, i.e., in this example, they are both right-handed screw threads in this example. The motors 10, 11 are configured such that they lie on opposing sides of the wormwheel gear 4 (motor 10 lies on one side of a virtual plane perpendicular to axes of the worm screws 6, 7 and passing through the centre point of the wormwheel gear 4 while motor 11 lies on the other side of this virtual plane).

Application of torque by a driver in a clockwise direction indicated by solid arrow 28 results in rotation of the handwheel 26 and the steering column shaft 3 about the dashed line 5. This rotation is detected by a rotation sensor (not shown). The first motor 10 is then controlled by the ECU 20 to apply torque in the opposite direction as indicated by dashed arrow 30.

The net result of the torques 30, 32, 34 applied by the first and second motors 10, 11 results in an application of a feedback torque to the steering column shaft 3 and handwheel 26, as indicated by a dashed arrow 36, to provide a sensation of road feel to the driver. In this example, the application of a feedback torque is in the opposite direction to that applied to the steering wheel 26 by the driver. In this way, the “rattle” produced between the worm screws 6, 7 and the wormwheel gear 4 can be eliminated or significantly reduced.

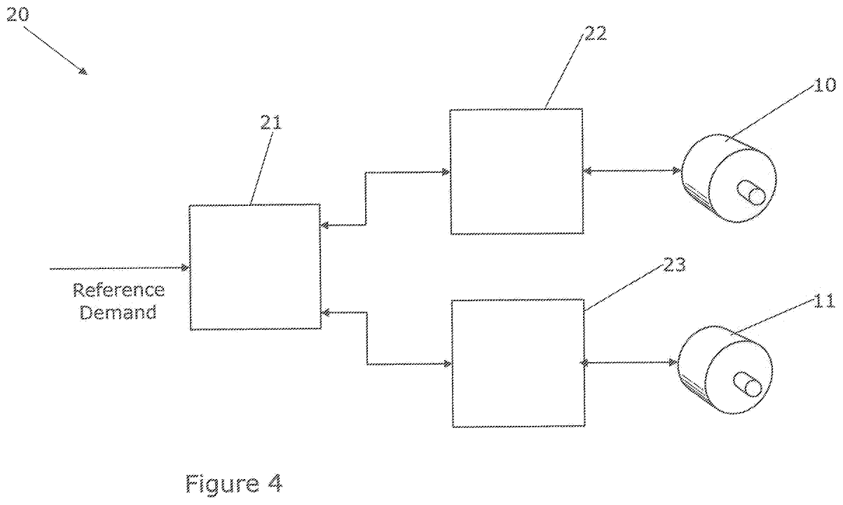

FIG. 4 shows part of an HWA assembly (80) showing a general arrangement of an electronic control unit (ECU) 20 which controls each of the two motors 10, 11. The ECU 20 may include a hand wheel actuator (HWA) control system 21 as well as a first and second motor controller 22, 23 which control the first and second motors 10, 11 respectively. The HWA control may be implemented by a separate ECU in other arrangements. A reference demand signal is input to the HWA control system 21 which allocates torque demands to each of the first and second motors 10, 11. These motor torque demands are converted to motor current demands and transmitted to the first and second motor controllers 22, 23. Each motor 10, 11 provides operating feedback to their respective motor controller 22, 23. The HWA control system 21 is configured to calculate the magnitude of mechanical friction using the motor torque demands. In another exemplary arrangement, the HWA control system 21 may be implemented by a separate ECU to the first and second motor controller 22, 23.

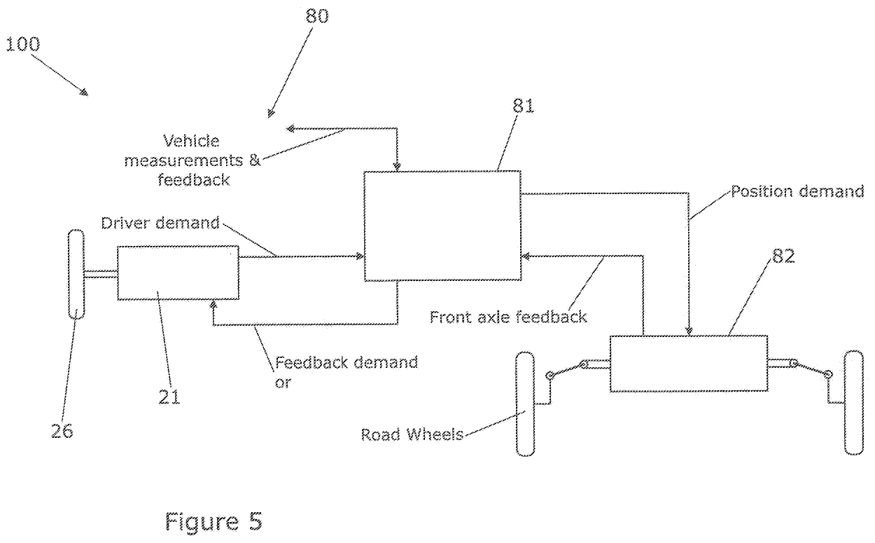

FIG. 5 shows an overall layout of a Steer-by-Wire system 100 for a vehicle including handwheel actuator (HWA) assembly 80 using a dual motor drive assembly 1 according to a first aspect of the disclosure. The HWA assembly 80 supports the driver's handwheel 26 and measures the driver demand which is usually the steering angle. A steering controller 81 converts the driver demand into a position demand that is sent to a front axle actuator (FAA) 82. The FAA 82 controls the steering angle of the roadwheels to achieve the position demand. The FAA 82 can feedback operating states and measurements to the steering controller 81.

The steering controller 81 combines the FAA 82 feedback with other information measured in the vehicle, such as lateral acceleration, to determine a target feedback torque that should be sensed by a driver of the vehicle. This feedback demand is then sent to the HWA control system 21 and is provided by controlling the first and second motors 10, 11 with the first and second motor controllers 22, 23 respectively.

FIG. 5 shows the steering controller 81 as physically separate to both the HWA controller 21 and the FAA 82. Alternately, different architectures, where one or more of these components are physically interconnected, may be used within the scope of this disclosure. For example, the functions of the steering controller 81 may be physically implemented in the HWA controller 21, the FAA 82, or another control unit in the vehicle, or some combination of all 3. Alternatively, control functions ascribed to the HWA controller 21 and FAA 82 may be partially or totally implemented in the steering controller 81.

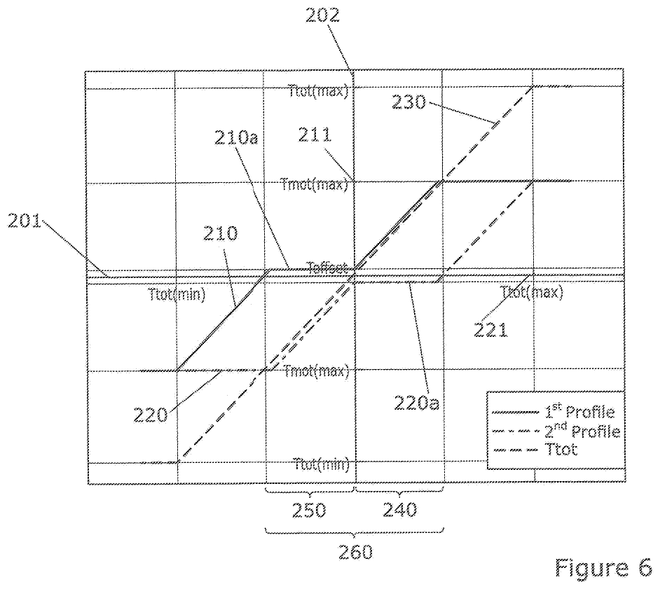

The relationship between the total torque demanded to provide feedback to the driver (x-axis) 201 and the feedback torque applied (y-axis) 202 for a dual motor drive assembly according to a first aspect of the disclosure is shown in FIG. 6.

The dual motor drive assembly 1 further comprises an allocating torque demand arrangement to each of the first and second motors 10, 11. A first profile 210, shown as a solid line in FIG. 6, defines a relationship between a total torque demanded for the shaft and the torque demand allocated to one of the first and second motors 10, 11. When the dual drive assembly 1 is allocating torque according to a first mode, the first profile 210 represents the torque applied by the first motor 10. A second profile 220, shown as a dot-dash line in FIG. 6, defines a different relationship between a total torque demanded for the shaft and the torque demand allocated to one of the first and second motors 10, 11. When the dual drive assembly 1 is allocating torque according to a second mode, the second profile 220 represents the torque applied by the second motor 11. The net torque applied by the two motors is represented by dashed line 230.

In a first torque range 240 where torque is positive, the first motor 10 applies a torque shown by profile 210 to provide feedback to the steering column shaft 3 and handwheel 26, while the second motor 11 applies a smaller magnitude torque known as an “offset torque” in the opposite direction (shown by profile 210) to provide an “active” lock to eliminate or reduce transmission rattle. The roles of the motors change depending in which direction the driver is steering. In a second torque range 250 where the torque is negative, the second motor 110 applies a feedback torque 220 to the steering column shaft 3 and the first motor 10 applies a smaller magnitude “offset” torque in the opposite direction.

The offset torque 210a applied by the first motor 10 is indicated by the constant torque region located within the second torque range 250.

The offset torque 220a applied by the second motor 11 is indicated by the constant torque region located within the first torque range 240.

Together, the first torque range 240 and second torque range 250 extend across a low torque region 260.

It can be seen in FIG. 6 that as the total torque demanded increases from zero the first motor 10 provides an increasing applied torque 210 until a maximum output 211 for the first motor 10 is reached. As the total torque demanded further increases, the applied torque 220 provided by the second motor 11 increases such that both motors 10, 11 are applying a torque in the same direction (e.g., positive in the top right quadrant) to the first wormwheel gear 4. The net torque 230 applied by the two motors 10, 11 can be seen to increase at a constant rate from zero until a maximum output 221 for the second motor 11 is reached, at which point both the first and second motors have reached their maximum output torques 211, 221 and the net torque 230 plateaus.

In the low torque region 260 the torque allocation unit for allocating torque demands to each of the first and second motors 10, 11 is allocating torque to the first and second motors 10, 11 such that each output worm screw 6, 7 applies an opposing torque to the wormwheel gear 4, in order to control mechanical backlash.

FIG. 6 shows example torque values where one motor reaches its maximum torque output before the other motor cross over such that both motors are working together. In other examples, any torque profiles may be used. For example, the second motor may cross over to work with the first motor before the first motor reaches a maximum output torque, and vice versa. In this way, both motors spend less time at maximum output torque as higher total torques can be provided before a motor reaches maximum output torque. This in turn reduces losses and increases working life.

After a motor has crossed over to work with the other motor, as the total demanded torque increases the allocated torque demands may become equal. Both motor torques may become equal prior to either motor reaching a maximum output torque. The point at which the motors go from outputting different torque value to outputting an equal torque may be described as a blending point. For any demanded total torque above the blending point where the allocated torque demands become equal, the allocated torque demands to both motors may increase at an equal rate. In this way, there may be a torque range up to an including the maximum total torque where the torque demands to both motors are equal. In some examples, at the blending point the allocated torque demands may switch from the first profile 210 to the second profile 220, or vice versa. As the output torque from the first and second motor 10, 11 is equal, the switch is smooth.

The dual drive motor assembly further comprises an observation unit for observing a differential motion of the two motors 10, 11 under a positive and a negative differential torque. For example, this may be achieved by implementing one or more motor angle sensors (not shown).

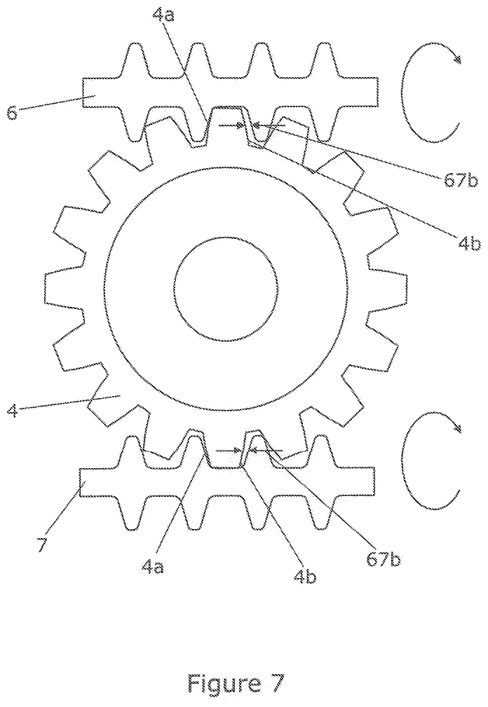

FIG. 7 shows the interaction between the first worm 6, second worm and the wormwheel gear 4 when the total demanded torque is in the low torque region 260 and a positive differential torque is applied (between the first motor 10 and the second motor 11).

The torque allocations to the motors 10, 11 are configured such that the worm screws 6, 7 rotate clockwise and apply opposing torques to the wormwheel gear 4. In this way, flanks 4a on the left-hand side of the wormwheel gear 4 as shown in FIG. 7 are in contact with the worm screws 6, 7 whilst flanks 4b on the opposing side of the same teeth are not. Typically, there is clearance in the assembly in the form of gaps between the wormwheel gear 4 and the teeth of the first and second worm 6, 7. When there is a positive differential torque applied, a first backlash 67a will be present caused by gaps between flanks 4b of the wormwheel gear 4 and corresponding flanks of teeth of the first and second worm screws 6,7.

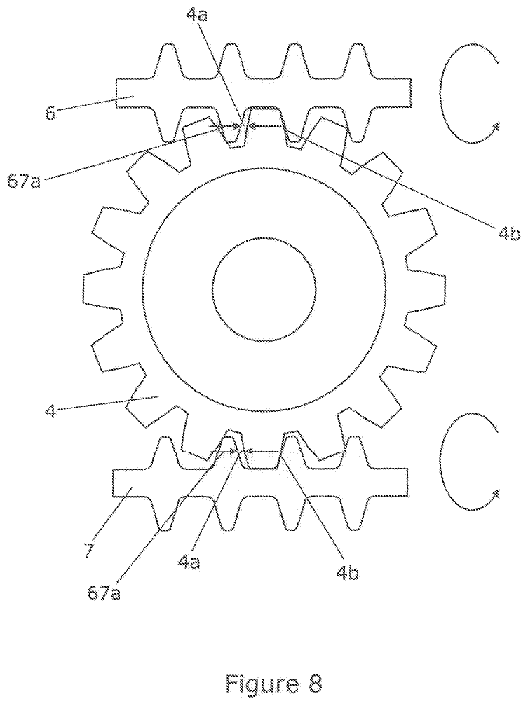

FIG. 8 shows the interaction between the first worm 6, second worm 7 and the wormwheel gear 4 when the total demanded torque is in the low torque region 260 and a negative differential torque is applied (between the first motor 10 and the second motor 11).

Each of the torques allocated to the first and second motors 10, 11 is in an opposing direction to FIG. 7 where a positive differential torque is applied. As shown in FIG. 8, the flanks 4b on the right-hand side of the wormwheel gear 4 are in contact with the worm screws 6, 7 whilst the flanks 4a on the opposing side of the same teeth are not. When there is a negative differential torque applied, a second backlash 67b will be present caused by gaps between flanks 4a of the wormwheel gear 4 and corresponding flanks of teeth of the first and second worm screws 6, 7.

Within the low torque region 260 the torque allocated to the first motor 10, where a positive differential torque is applied, is in an opposing direction to the torque allocated to the first motor 10 where a negative differential torque is applied. Similarly, the torque allocated to the second motor 11, where a positive differential torque is applied, is in an opposing direction to the torque allocated to the second motor 11 where a negative differential torque is applied. By providing a processing arrangement operable to switch the torque allocations between positive torque differential and a negative torque differential at two moments in time an estimate of the total backlash in the gearbox may be calculated. The total backlash is an indication of the wear of a gearbox. In response to this calculation, worn out components may then be replaced during servicing. This can be performed during a special calibration process, for instance at power up or power down or at any time during operation of the motor where suitable torques are being applied by the motors. Operation within the low torque mode provides plenty of opportunity to take measurements that can be used to determine backlash as will be explained hereinafter.

Total backlash in the gearbox may be estimated when the dual drive motor assembly 1 is not providing feedback to the driver, for example during pourer up or power down of the assembly 1 or while the vehicle is operating semi-autonomously. In this way, a closed-loop control system may be used to hold the handwheel at a substantially constant angle by varying the differential torque.

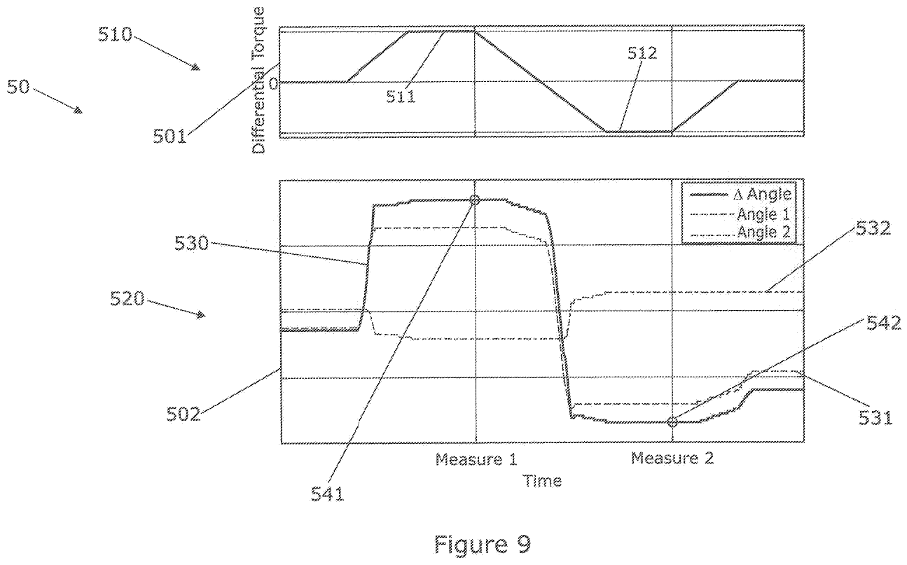

One example of an appropriate operating scheme 50 implemented by a closed-loop control system is shown in FIG. 9.

A schematic relationship of differential torque (y-axis 501) over time (x-axis) is shown in a first plot 510 of FIG. 9 (top graph) alongside a second plot 520 showing a corresponding relationship of motor angle (y-axis 502) over time (x-axis) recorded by the observation unit for observing a differential motion of the two motors 10, 11 (bottom graph). The two plots of FIG. 9 are aligned such that their time axes (x-axes) are coincident.

Dashed line 531 represents the angular position of the first motor 10 while dot-dashed line 532 represents the angular position of the second motor 11. Solid line 530 represents the angular differential motion between the first motor 10 and the second motor 11. As shown in FIG. 9, an operating scheme 50 may be implemented such that the differential torque switches between a positive differential torque 511 and a negative differential torque 512. A magnitude of the positive and negative differential torques 511, 512 may be selected to be sufficient to overcome any friction in the gearbox and ensure that the wormshafts 6, 7 are fully contacting the flanks 4a, 4b of the wormwheel gear 4. The operating scheme 50 may be configured such that the positive differential torque 511 and negative differential torque 512 are held for a set time period which is set to allow the measurements of the angular positions 531, 532 of the first and second motors to equilibrate, defining respective first and second moments in time.

While the angular positions 531, 532 of the first and second motors are equilibrated a data point (for that moment in time) of the angular differential motion may be recorded. The motors, once free play associated with backlash has been taken up, will rotate at the same speed but the relative angular position of the first motor and the second motor will be different for each direction of rotation of the shaft where there is backlash.

FIG. 9 shows a data point 541 representing the angular differential motion between the first and second motors 10, 11 when the positive differential torque 511 is applied. Similarly, a further data point 542 is shown representing the angular differential motion between the first and second motors 10, 11 when the negative differential torque 512 is applied. An estimate of the total backlash may then be calculated according to Equation 1.

$$= \frac{( {α}_{1 ( pos )} - {α}_{2 ( pos )} ) - ( {α}_{1 ( neg )} - {α}_{2 ( neg )} )}{2} \qquad Equation 1$$

Where [symbol] represents the estimate of the total backlash, α₁₍ₚₒₛ₎ and α₂₍ₚₒₛ₎ represent the angular positions of the first and second motors 10, 11 respectively when the positive differential torque 511 is applied, and α_{1(neg)} and α_{2(neg)} represent the angular positions of the first and second motors 10, 11 respectively when the negative differential torque 512 is applied. α₁₍ₚₒₛ₎, α₂₍ₚₒₛ₎, α_{1(neg)} and α_{2(neg)} recorded while the angular positions 531, 532 of the first and second motors are equilibrated.

Angular positions of the first and second motor are likely to be measured as greater magnitude when a greater absolute torque is applied to each of the first and second motors 10, 11. To account for this effect, the total backlash estimated may be augmented using an estimate of the compliance in the gearbox. This can be done by configuring the operating scheme 50 to further include additional plots, similar to the examples shown in FIG. 9 but with greater magnitude of both the positive differential torque 511 and the negative differential torque 512, The total backlash may then be calculated for each torque magnitude such that a constant component of the total backlash may be extrapolated and a varying component of the total backlash, which represents the effect of compliance, can be accounted for.

In another exemplary arrangement of the disclosure, the total backlash in the gearbox may be estimated when the dual drive motor assembly 1 is active. In this example, the total backlash may be estimated at every possible opportunity during normal operation to achieve a stored value of the total backlash estimate continuous updated. The angular differential motion between the first and second motors 10, 11 may be recorded whenever a steering column angular velocity and acceleration are low and the applied torque is sufficient to ensure that the worm screws 6, 7 are fully engaged with the wormwheel gear 4. In this exemplary arrangement, the polarity of the differential torque is swapped (i.e., from a positive differential torque to a negative differential torque and vice versa) during active use of the dual motor drive assembly by a user. This may be achieved by repeatedly switching the dual motor drive assembly from the first mode to a second mode. In a second mode, the torque allocated to each of the first and second motors 10, 11 is swapped. That is to say that in the second mode, the torque allocated to the first motor 10 follows the second profile 220 and the torque allocated to the second motor 11 follows the first profile 210. The dual motor drive assembly may be periodically switched from the first mode to a second mode at regular time intervals.

Similarly to the first mode, when the allocation unit for allocating torque demands to each of the first and second motors 10, 11 allocates torque within the low torque region 260 according to the second mode, each worm screw 6, 7 applies an opposing torque to the wormwheel gear 4. The total backlash in the gearbox may therefore be estimated when the total demand torque is within the low torque range 260 and the differential motion of the first and second motors when operating in both the first and second modes is measured.

Repeatedly switching the dual motor drive assembly 1 from the first mode to the second mode may also mean that the wormwheel flanks 4a, 4b will be more evenly worn.

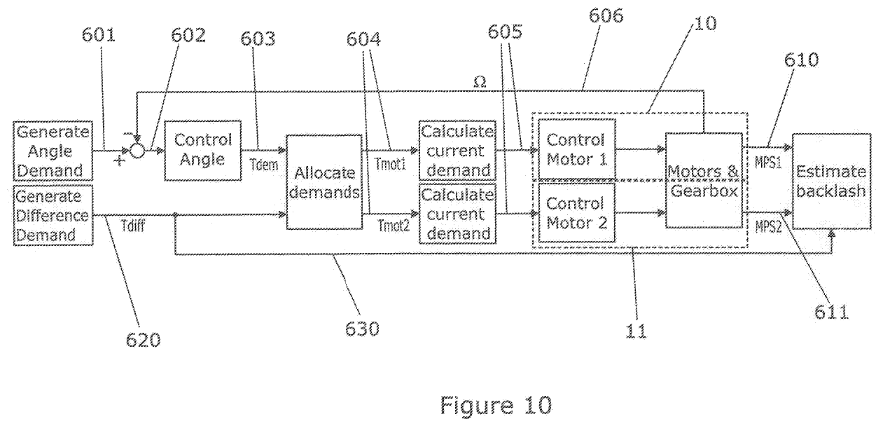

FIG. 10 shows an example of a closed-loop control system 600 for estimating backlash. Such a closed-loop control system 600 may be used to hold the handwheel while varying the differential torque.

As shown in FIG. 10, the closed-loop control system 600 includes an angle generation unit to generate a pre-set angle demand profile 601. The pre-set angle demand profile 601 may be compared with a measured angle, or average measured angle 606 to form an angular error 602. The net torque demand 603, is set to control the angle to match the modified angle demand profile 601. The closed-loop control system 600 further includes a means to generate pre-set torque differential demand profile 620 synchronised with the modified angle demand profile 601. The torque differential demand profile 620 and the net torque demand 603 are used to calculate torque demands 604 for each of the first and second motors 10, 11. For example, the torque demands 604 may be calculated according to Equations 2 and 3.

Tₘₒₜ₁=(1/N_{gb})(T_{dem}+T_{diff})/2 Equation 2

Tₘₒₜ₂=(1/N_{gb})(T_{dem}−T_{diff})/2 Equation 3

Where N_{gb} represents a gearbox ratio, Tₘₒₜ₁ the first motor 10 demand torque, Tₘₒₜ₂ the second motor 11 demand torque, T_{dem} the total demand torque and T_{diff} represents the differential torque 620.

Corresponding current demands 605 are calculated for each of the torque demands 604, and fed to the controller of the first and second motors 10, 11. The system 600 further comprises an observation unit for observing the angular position 610 of the first motor 10 and the angular position 611 of the second motor 11. The average angle 606 is calculated and fed back into the system 600 to form an angle control loop.

Using the angular position 610 of the first motor 10 and the angular position 611 of the second motor 11 an angular differential motion between the first and second motors 10, 11 is calculated and an estimate of the total backlash may be calculated. The total backlash estimated may be augmented using an estimate of the compliance in the gearbox at the differential torque 620 at which the total backlash had been estimated. This is shown by arrow 630 in FIG. 10.

It will be understood that the disclosure is not limited to the exemplary arrangements described above. Various modifications and improvements can be made without departing from the concepts disclosed herein. Except where mutually exclusive, any of the features may be employed separately or in combination with any other features and the disclosure extends to all combinations and sub-combinations of one or more features disclosed herein.

1. A dual motor drive assembly, for use in a handwheel actuator assembly of a vehicle, comprising:
a housing;
a shaft rotatably mounted with respect to the housing;
a first gear connected to and configured to rotate with the shaft;
first and second motors, each having an output driving a respective output gear, the output gears being engaged with the first gear;
a motor controller which allocates torque demands to each of the first and second motors to cause each motor to apply a respective torque to the first gear,
a position determining unit arranged to determine a respective angular position signal indicative of the angular position of the first motor and the angular position of the second motor,
and a processing unit which is arranged to:
receive the angular position signals at a first time when the motor controller allocates a torque demand to the motors that produces a differential torque at the shaft having a first sense; the differential torque being sufficient to overcome friction between the gears and to ensure that any free play between the two output gears and the first gear is taken up;
receive the angular position signals at a second time when the motor controller allocates a torque demand to the motors that produces a differential torque at the shaft having a second, opposite sense, the differential torque being sufficient to overcome friction between the gears and to ensure that any free play between the two output gears and the first gear is taken up,
and in which the processing unit is arranged to estimate the level of backlash in a gearbox as a function of the values of the angular position signals at the first and second times.

2. The dual motor drive assembly according to claim 1 wherein an arrangement for allocating torque demands comprises an electronic control unit.

3. The dual motor drive assembly according to claim 1, wherein the position determining unit comprises at least one motor position sensor.

4. The dual motor drive assembly according to claim 1, wherein an individual motor position sensor is used to measure a motor angle of each of the first and second motors.

5. The dual motor drive assembly according to claim 1, wherein the dual motor drive assembly comprises an estimator unit to estimate the level of backlash in the gearbox whilst controlling the average shaft rotation velocity.

6. The dual motor drive assembly according to claim 1, comprising an estimator unit to estimate the level of backlash by observing a differential motion of the two motors during a power-up or power-down sequence.

7. The dual motor drive assembly according to claim 6 wherein a closed-loop control system is used to hold the output shaft at a substantially constant angle by varying the torque demand to both motors.

8. The dual motor drive assembly according to claim 1, comprising an estimator unit to estimate the level of backlash by observing a differential motion of the two motors during a period of operation with near-zero motion of the output shaft.

9. The dual motor drive assembly according to claim 1, comprising estimator unit to estimate the compliance in the gearbox by observing a wind-up in the gearbox with two or more levels of differential torque applied.

10. The dual motor drive assembly according to claim 9 wherein to estimate the compliance in the gearbox, a greater torque demand is applied in comparison to the torque demand applied to estimate the backlash.

11. The dual motor drive assembly according to claim 1, comprising a monitoring arrangement to continuously monitor the gearbox backlash by measuring the differential motion of the two motors whenever the two motors are driving in opposition.

12. The dual motor drive assembly according to claim 11 wherein the differential motion of the two motors is measured when a total torque demand is at or above a pre-determined value, the pre-determined value being approximately an amount sufficient to fully engage the teeth of the first gear and output gears.

13. A method of operating a dual motor drive assembly, for use in a handwheel actuator assembly of a vehicle, comprising:
a housing;
a shaft rotatably mounted with respect to the housing;
a first gear connected to and configured to rotate with the shaft;
first and second motors, each having an output driving a respective output gear, the output gears being engaged with the first gear;
wherein the method comprises the steps:
(a) allocating torque demands to each of the first and second motors, wherein the first and second motors apply opposing torques to the first gear resulting in an overall differential torque at the shaft which is sufficient to overcome friction between the gears and to ensure that any free play between the two output gears and the first gear is taken up;
(b) switching polarities of the torque applied by both the first and second motors between a first moment in time and a second moment in time wherein at the first moment in time the differential torque at the shaft applied by the motors is opposite in value to the differential torque at the second moment in time; and
c) measuring the differential motion of the two motors at the two moments in time, wherein the level of backlash in the gearbox is estimated using the differential motion of the first and second motors.

14. The dual motor drive assembly according to claim 2, wherein an individual motor position sensor is used to measure a motor angle of each of the first and second motors.

15. The dual motor drive assembly according to claim 14, wherein the dual motor drive assembly comprises an estimator unit to estimate the level of backlash in the gearbox whilst controlling the average shaft rotation velocity.

16. The dual motor drive assembly according to claim 15, comprising an estimator unit to estimate the level of backlash by observing a differential motion of the two motors during a power-up or power-down sequence.

17. The dual motor drive assembly according to claim 14, comprising an estimator unit to estimate the level of backlash by observing a differential motion of the two motors during a period of operation with near-zero motion of the output shaft.

18. The dual motor drive assembly according to claim 14, comprising an estimator unit to estimate the compliance in the gearbox by observing a wind-up in the gearbox with two or more levels of differential torque applied.

19. The dual motor drive assembly according to claim 18, comprising a monitoring arrangement to continuously monitor the gearbox backlash by measuring the differential motion of the two motors whenever the two motors are driving in opposition.
